(19) United States
(12) Patent Application Publication
(10) Pub. No.: US 2026/0121491 A1
(43) Pub. Date: Apr. 30, 2026

(54) VEHICLE CONTROL DEVICE AND VEHICLE DRIVE DEVICE

(71) Applicant: Aisin Corporation, Kariya (JP)

(72) Inventors: Yuki NAGAI, Kariya-shi (JP); Hidefumi KOASHI, Kariya-shi (JP); Yuya MIZUNO, Kariya-shi (JP); Keisuke TAKEMOTO, Kariya-shi (JP); Kenta GOTO, Kariya-shi (JP)

(73) Assignee: Aisin Corporation, Kariya (JP)

(21) Appl. No.: 19/336,644

(22) Filed: Sep. 23, 2025

(30) Foreign Application Priority Data
Oct. 25, 2024 (JP) 2024-188136

(51) Int. Cl. H02K 11/33; F16H 57/02; F16H 57/025; F16H 57/04; F16H 61/00; H02K 5/20; H02K 7/00; H02K 7/116

(52) U.S. Cl. CPC H02K 11/33; F16H 57/025; F16H 57/0421; F16H 61/0009; H02K 5/203; H02K 7/006; H02K 7/116; F16H 2057/02034; F16H 57/0412

(57) ABSTRACT

Provided is a vehicle control device that enables deformation of a control case to be easily suppressed. The vehicle control device includes: a control module; a pair of mounting members that are connected to a vehicle body of a vehicle; and a control case that houses the control module, the control case includes: a pair of mounting fixing portions to which each of the pair of mounting members is fixed; and a heat exchange portion forming inside a flow path through which a heating medium for performing heat exchange with the control module flows, and the heat exchange portion is arranged at a position sandwiched between the pair of mounting fixing portions and is integrally formed with the pair of mounting fixing portions.

### CROSS REFERENCE TO RELATED APPLICATIONS

This application is based on and claims priority under 35 U.S.C. § 119 to Japanese Patent Application 2024-188136, filed on Oct. 25, 2024, the entire content of which is incorporated herein by reference.

### TECHNICAL FIELD

This disclosure generally relates to a vehicle control device and a vehicle drive device that include a pair of mounting members.

### BACKGROUND DISCUSSION

In WO2020/084989A (Reference 1), a vehicle drive device including a pair of mounting members (8L and 8R) is disclosed. In the vehicle drive device, a drive device case (2) is connected to a vehicle body (6L and 6R) via the pair of mounting members (8L and 8R).

Meanwhile, when the vehicle drive device is connected to the vehicle body, it is conceivable that a control case that houses a control module required for control of a motive power source and the like of the vehicle, instead of a drive device case that houses the motive power source, a gear mechanism, or the like of the vehicle, is connected to the vehicle body by a pair of mounting members as described in Reference 1. However, a possibility that, during traveling, the control case may be deformed due to a load exerted from the pair of mounting members on the control case is conceivable. In addition, when the deformation of the control case on this occasion is significant, a possibility that a load is applied to the control module in the control case is conceivable.

A need thus exists for a vehicle control device, which is not susceptible to the drawback mentioned above.

### SUMMARY

A vehicle control device according to this disclosure is a vehicle control device including: a control module that includes an inverter for drive-controlling a rotary electric machine, and at least one of a voltage conversion circuit performing conversion of voltage for an in-vehicle battery, a charging circuit for performing charging from an external power source to the in-vehicle battery, and a power supply circuit for performing power supply from the in-vehicle battery to an outside, being electrically connected to the in-vehicle battery; a pair of mounting members that are connected to a vehicle body of a vehicle; and a control case that houses the control module, the control case includes: a pair of mounting fixing portions to which each of the pair of mounting members is fixed; and a heat exchange portion forming inside a flow path through which a heating medium for performing heat exchange with the control module flows, and the heat exchange portion is arranged at a position sandwiched between the pair of mounting fixing portions and is also integrally formed with the pair of mounting fixing portions.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a skeleton diagram illustrating a vehicle in which a vehicle control device is mounted;

FIG. 2 is a circuit block diagram illustrating a control module that is mounted on the vehicle in FIG. 1;

FIG. 3 is a top view of a control case that is mounted on the vehicle in FIG. 1; and

FIG. 4 is a cross-sectional view of the control case that is mounted on the vehicle in FIG. 1 and is a diagram illustrating a cross section taken along a line III-III in FIG. 3.

### DETAILED DESCRIPTION

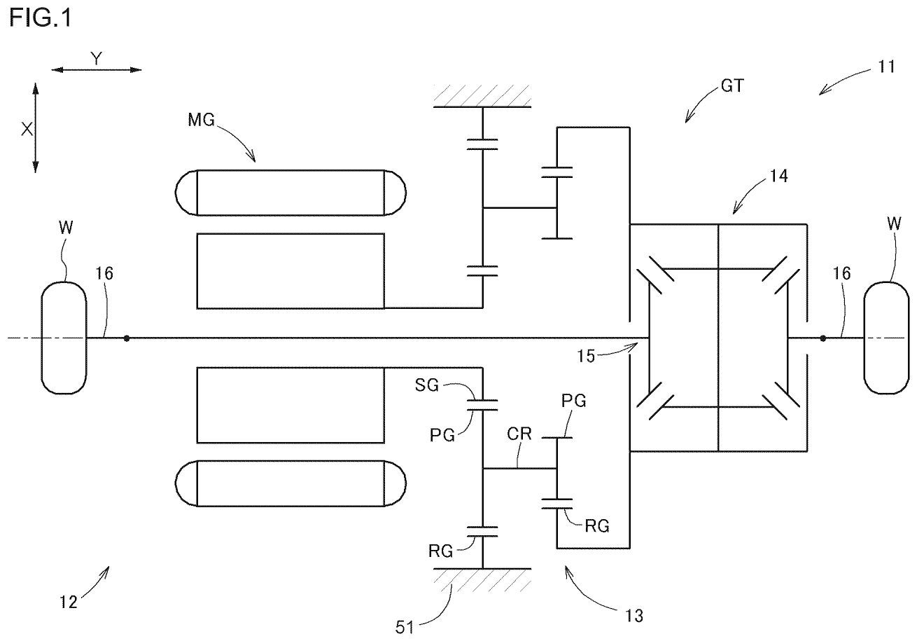

An embodiment of a vehicle control device 10 is described below with reference to the drawings. FIG. 1 is a diagram illustrating an example of a vehicle 12 in which the vehicle control device 10 is mounted. The vehicle control device 10 is installed in a vehicle drive device 11.

The vehicle drive device 11 includes a rotary electric machine MG. In this embodiment, the rotary electric machine MG is a driving force source of the vehicle 12. Examples of the vehicle 12 include a battery electric vehicle (BEV), a fuel cell electric vehicle (FCEV), a hybrid electric vehicle (HEV) that includes an internal-combustion engine and a rotary electric machine, a plug-in hybrid electric vehicle (PHEV), and the like. The vehicle 12 may be a three-wheel vehicle or a four-wheel vehicle. In this embodiment, the vehicle 12 is a four-wheel vehicle. The vehicle 12 includes batteries (BH and BL). The vehicle 12 includes a pair of wheels W.

One direction in a direction orthogonal to an up-down direction Z, that is, a horizontal direction, is defined as a first direction X. As used herein, the up-down direction Z means the vertical direction while the vehicle drive device 11 is mounted in the vehicle 12. In addition, a direction orthogonal to both the up-down direction Z and the first direction X is defined as a second direction Y. In this embodiment, the second direction Y is a direction parallel with a rotation axis of the wheels W. Note that the second direction Y may be a direction orthogonal to the rotation axis of the wheels W.

The rotary electric machine MG has a function as a motor that generates motive power upon receiving supply of electric power and a function as a generator that generates electric power upon receiving supply of motive power. Specifically, the rotary electric machine MG is electrically connected to an electric power storage device (illustration is omitted), such as a battery and a capacitor. The rotary electric machine MG performs power running by using electric power stored in the electric power storage device and thereby generates driving force. In addition, the rotary electric machine MG generates electric power by driving force transmitted from the wheels W and charges the electric power storage device. In this embodiment, the rotary electric machine MG is a rotary electric machine of inner rotor type. The vehicle drive device 11 includes a drive device case 51 that houses the rotary electric machine MG.

The vehicle drive device 11 includes an output member 15 that is drivingly connected to the wheels W. As used herein, “being drivingly connected” means a state in which two rotational elements are connected to each other in such a manner that driving force can be transmitted therebetween, and includes a state in which the two rotational elements are connected to each other in such a manner as to integrally rotate or a state in which the two rotational elements are connected to each other in such a manner that driving force can be transmitted therebetween via one or two or more transmission members. Examples of such a transmission member include various types of members that transmits rotation at the same speed or by changing speed, such as a shaft, a gear mechanism, a belt, and a chain. Note that examples of the transmission member may include an engagement device that selectively transmits rotation and driving force, such as a friction engagement device and a gearing type engagement device. Note, however, that when the words “being drivingly connected” are used with respect to rotational elements of a planetary gear mechanism, it is assumed that the words indicate a state in which the rotational elements are drivingly connected without another rotational element in the planetary gear mechanism interposed therebetween.

The vehicle drive device 11 includes a motive power transmission mechanism GT. The motive power transmission mechanism GT transmits driving force between the rotary electric machine MG and the output member 15. In this embodiment, the motive power transmission mechanism GT includes a deceleration device 13 and a differential gear device 14. Driving rotation generated by the rotary electric machine MG is decelerated by the deceleration device 13 and distributed to a pair of wheels W by the differential gear device 14. The differential gear device 14 is drivingly connected to the wheels W via drive shafts 16.

In this embodiment, the deceleration device 13 is formed by using a planetary gear mechanism and includes a sun gear SG, a carrier CR, pinions PG, and ring gears RG. Because of this configuration, the deceleration device 13 decelerates the driving rotation generated by the rotary electric machine MG. Note that the deceleration device 13 may be a parallel shaft-type deceleration device using a counter gear or the like.

In this embodiment, the output member 15 is a rotational element constituting the differential gear device 14. Note, however, that without being limited to such a configuration, the output member 15 may also be rotational elements interposed between the differential gear device 14 and the drive shafts 16.

FIG. 1 illustrates as an example a so-called monoaxial E-axle where a plurality of main rotational elements constituting the vehicle drive device 11 are arranged coaxially within the drive device case 51. Note, however, that without being limited to such a configuration, the vehicle drive device 11 according to this disclosure may also be applied to a so-called triaxial E-axle where the main rotational elements are, for example, arranged in a distributed manner on three axes.

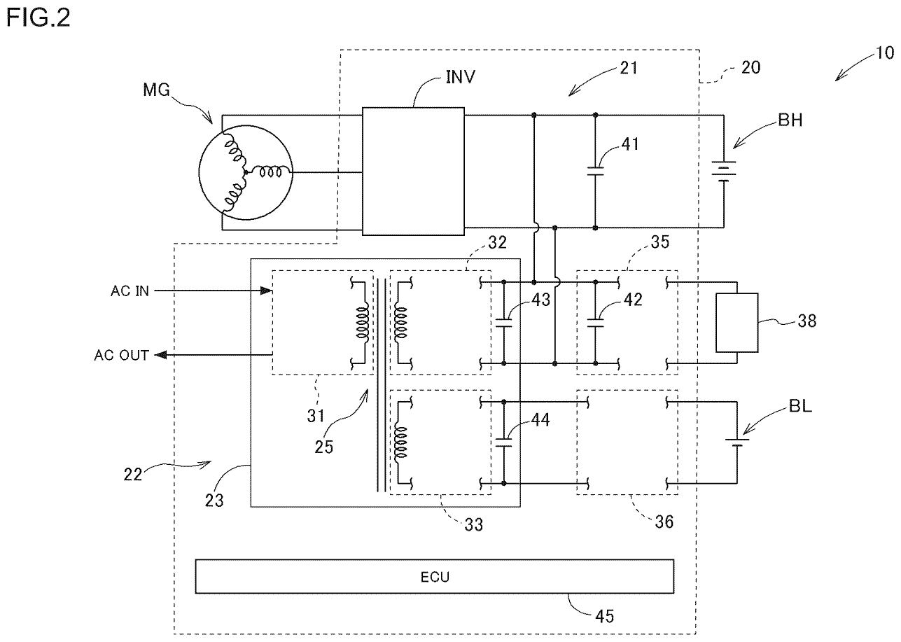

FIG. 2 is a circuit block diagram illustrating an example of a control module 20. The vehicle control device 10 includes the control module 20. The rotary electric machine MG is connected to in-vehicle batteries (a first battery BH and a second battery BL) via an inverter INV.

The control module 20 includes the inverter INV to drive-control the rotary electric machine MG and at least one of a voltage conversion circuit, a charging circuit, and a power supply circuit that are electrically connected to the in-vehicle batteries.

The control module 20 includes an inverter module 21. The inverter module 21 drive-controls the rotary electric machine MG. The control module 20 includes a power source module 22. The power source module 22 has at least one of functions of the voltage conversion circuit, the charging circuit, and the power supply circuit.

The “voltage conversion circuit” is a circuit that performs voltage conversion for the in-vehicle batteries. In the illustrated example, a first DC-DC converter 35 and a second DC-DC converter 36 have the function of the voltage conversion circuit. The “charging circuit” is a circuit for charging the in-vehicle batteries (BH and BL) from an external power source. The “power supply circuit” is a circuit for supplying electric power from the in-vehicle batteries to the outside. In this embodiment, an in-vehicle charger 23 has functions of the charging circuit and the power supply circuit. Note that the in-vehicle charger 23 may be configured to include only the function of the charging circuit. In addition, a power supply circuit different from the in-vehicle charger 23 may be provided in the control module 20.

In this embodiment, the in-vehicle batteries include the first battery BH that is a high-voltage battery. The first battery BH is configured to be connectable to an external power source via the in-vehicle charger 23 including the charging circuit. The first battery BH is a DC power source that is formed of a chargeable secondary battery, such as a lithium-ion battery, or an electric power storage device, such as an electric double layer capacitor. Rated voltage of the first battery BH is approximately 200 to 800 volts.

The in-vehicle batteries include the second battery BL that has a lower rated voltage than the first battery BH. The second battery BL is configured to be chargeable with power supplied from the first battery BH. The second battery BL is configured to be chargeable with power supplied from an external AC power source. Rated power source voltage of the second battery BL is, for example, approximately 12 to 24 volts.

In this embodiment, the control module 20 includes the first DC-DC converter 35. The first DC-DC converter 35 steps down DC power supplied from the first battery BH. The DC power stepped down by the first DC-DC converter 35 is supplied to an auxiliary machine rotary electric machine 38 that is a driving force source of an auxiliary machine. Examples of the auxiliary machine include an air conditioner, an electric oil pump, and the like.

The in-vehicle charger 23 of this embodiment includes a dual active bridge (DAB) circuit including a transformer 25 and converts AC power (AC IN) supplied from an external AC power source side to first DC power and second DC power. When viewed from an AC side, the transformer 25 includes a primary-side coil and two secondary-side coils.

For example, a first circuit 31 is formed with a full-bridge circuit, which is formed of switching elements, connected to the primary-side coil. A second circuit 32 is formed with a full-bridge circuit connected to a first secondary-side coil. A third circuit 33 is formed with a full-bridge circuit connected to a second secondary-side coil.

The second circuit 32 generates first DC power to charge the first battery BH. The third circuit 33 generates second DC power having a lower voltage than the first DC power. In this embodiment, the control module 20 includes the second DC-DC converter 36. The second DC-DC converter 36 steps down voltage of the second DC power generated by the third circuit 33.

Between the first battery BH and the inverter INV, a first DC link capacitor 41 that functions as a smoothing capacitor to smooth voltage on a DC side of the inverter INV is installed.

On a first battery BH side of the first DC-DC converter 35, a second DC link capacitor 42 that functions as a smoothing capacitor to smooth DC voltage is installed. In an output portion of the second circuit 32, a third DC link capacitor 43 to smooth voltage of the first DC power is installed. In an output portion of the third circuit 33, a fourth DC link capacitor 44 to smooth voltage of the second DC power is installed.

The rotary electric machine MG is drive-controlled by a rotary electric machine control unit 45, based on a target torque for the rotary electric machine MG that is set in accordance with a command from a not-illustrated vehicle control device, which serves as a higher-level control device. The rotary electric machine control unit 45 switching-controls the inverter INV that is formed of a plurality of switching elements and thereby causes the inverter INV to convert electric power between DC and a plurality of phases (in this embodiment, three phases) of AC.

In this embodiment, the rotary electric machine control unit 45 constitutes an ECU in conjunction with a charging control unit that controls the in-vehicle charging device 23, a first voltage conversion control unit that controls the first DC-DC converter 35, a second voltage conversion control unit that controls the second DC-DC converter 36, and the like.

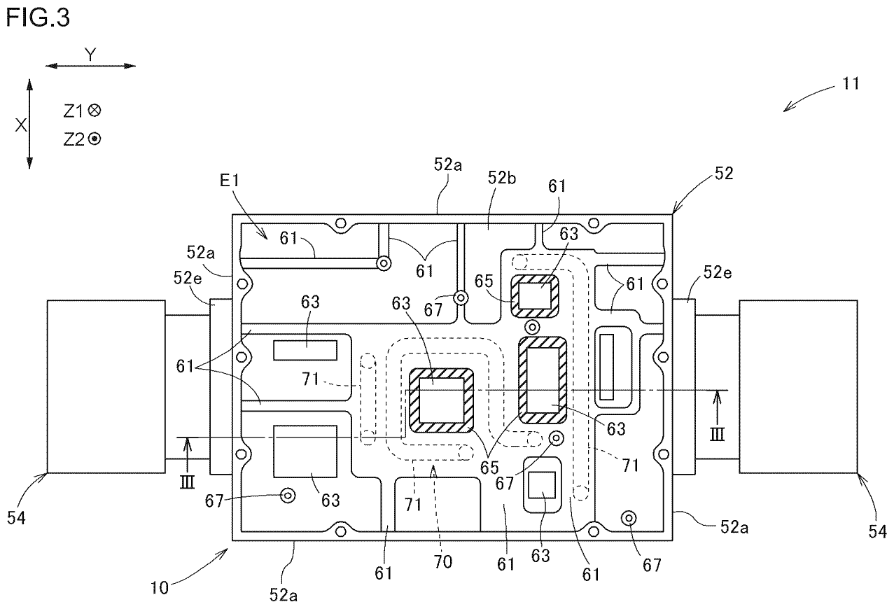

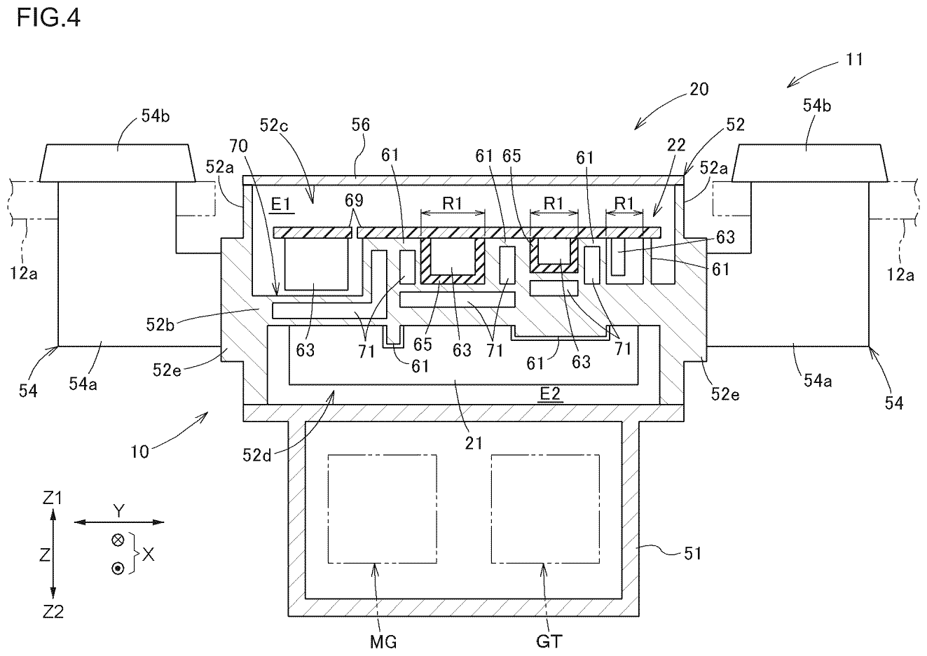

FIG. 3 is a top view illustrating an example of the drive device case 51 and a control case 52. FIG. 4 is a cross-sectional view illustrating the example of the drive device case 51 and the control case 52.

As illustrated in FIG. 4, the vehicle drive device 11 includes the drive device case 51 that houses the rotary electric machine MG and the motive power transmission mechanism GT. The vehicle control device 10 includes the control case 52 that houses the control module 20. Hereinbelow, an upper side and a lower side in the above-described up-down direction Z are referred to as an upper side Z1 and a lower side Z2, respectively. In this embodiment, the control case 52 is arranged on the upper side Z1 of the drive device case 51.

The control case 52 is joined to the drive device case 51 or is integrally formed with the drive device case 51. Examples of the joining include fastening by a bolt, riveting, welding, swaging, brazing, and the like. In this embodiment, the control case 52 is fastened to the drive device case 51 by a bolt.

Note that the control case 52 and the drive device case 51 may be integrally formed with each other by using the same material. Examples of being integrally formed by using the same material include forming by casting, forging, cutting, grinding, or the like.

The vehicle control device 10 includes a pair of mounting members 54 that are to be connected to a vehicle body 12a of the vehicle 12. In this embodiment, the pair of mounting members 54 is configured to support the control case 52 by suspending the control case 52 from the vehicle body 12a. In this embodiment, the second direction Y is a direction parallel with a direction pointing from one of the pair of mounting members 54 to the other.

The control case 52 is supported suspended from the vehicle body 12a by the pair of mounting members 54. Examples of the vehicle body 12a include a monocoque body, frame, and the like. Each of the mounting members 54 includes a mounting bracket 54a and a mounting bush 54b. The mounting bush 54b, for example, absorbs vibration from the control case 52 to a passenger cabin, an impact from a road surface to the control case 52, or the like.

As illustrated in FIG. 3, the control case 52 includes a side wall portion 52a. The side wall portion 52a is arranged at least on both sides in the second direction Y of the control module 20. In this embodiment, the side wall portion 52a is arranged on both sides in the first direction X and both sides in the second direction Y of the control module 20.

In this embodiment, the side wall portion 52a is arranged in such a manner as to surround the control module 20 from the outer side in horizontal directions. The side wall portion 52a is formed in, for example, a polygonal shape or a circular shape as viewed in the up-down direction. In this embodiment, the side wall portion 52a is formed in a rectangular shape as viewed in the up-down direction.

In this embodiment, the control module 20 is continuously surrounded by the side wall portion 52a. Note that the control module 20 may be intermittently surrounded by the side wall portion 52a.

As illustrated in FIG. 4, the control case 52 includes a bottom wall portion 52b. On the upper side Z1 of the bottom wall portion 52b, a first housing space E1 is arranged. On the lower side Z2 of the bottom wall portion 52b, a second housing space E2 is arranged. In this embodiment, each of the first housing space E1 and the second housing space E2 is a space continuously surrounded by the side wall portion 52a in horizontal directions.

In each of the first housing space E1 and the second housing space E2, at least a portion of the control module 20 is arranged. In this embodiment, the inverter module 21 is arranged in the second housing space E2. In this embodiment, the power source module 22 is arranged in the first housing space E1. In this embodiment, the rotary electric machine control unit 45 is arranged in the first housing space E1.

The bottom wall portion 52b covers at least a portion of the control module 20 from the lower side Z2. The bottom wall portion 52b is formed in such a manner as to connect sides of the side wall portion 52a to each other at least in the second direction Y. In this embodiment, the bottom wall portion 52b is formed in such a manner as to connect sides of the side wall portion 52a to each other in the first direction X and sides of the side wall portion 52a to each other in the second direction Y. The side wall portion 52a and the bottom wall portion 52b are integrally formed with each other by using the same material.

It is now assumed that a direction in which a pair of mounting fixing portions 52e are linked to each other is defined as a target direction. In this embodiment, the second direction Y is the target direction. In this embodiment, the bottom wall portion 52b is arranged at a position overlapping the pair of mounting fixing portions 52e in a target direction view along the target direction.

As used herein, two members “overlapping each other in a specific direction view” with regard to an arrangement of the two members means that when a virtual straight line that is parallel with the view direction is moved in directions orthogonal to the virtual straight line, a region in which the virtual straight line crosses both the two members exists.

The control case 52 has an upper-side opening 52c that opens to the upper side Z1. The control case 52 has a lower-side opening 52d that opens to the lower side Z2. The vehicle control device 10 includes a cover member 56 that covers the upper-side opening 52c of the control case 52. The cover member 56 is joined to the control case 52. In this embodiment, the cover member 56 is fasten to the control case 52 by a bolt.

The control case 52 includes the pair of mounting fixing portions 52e to each of which one of the pair of mounting members 54 is fixed. The pair of mounting fixing portions 52e and the side wall portion 52a are integrally formed with each other by using the same material. Examples of the pair of mounting fixing portion 52e include fastening portions for bolts, hole portions for rivets, welding portions, brazing portions, fitting portions, boss portions, and base portions on which the foregoing can be formed. In this embodiment, the mounting fixing portions 52e are portions of the control case 52 with which the mounting members 54 are in contact.

The pair of mounting fixing portions 52e are arranged on outer surfaces of the side wall portion 52a that face opposite to each other. The bottom wall portion 52b is formed to connect, in a horizontal direction, inner surfaces of the side wall portion 52a that face opposite to each other.

On the bottom wall portion 52b, a rib 61 projecting in at least one direction of the up-down direction Z and also extending in at least one direction of the horizontal direction is formed. In this embodiment, a rib 61 projects toward the first housing space E1. In this embodiment, a rib 61 projects toward the second housing space E2. In this embodiment, a plurality of ribs 61 are formed on the bottom wall portion 52b.

As illustrated in FIG. 3, on the bottom wall portion 52b, a pair of ribs 61 both of which project in at least one direction of the up-down direction Z and also extend in at least one direction of the horizontal direction are formed. In an inter-rib region R1 sandwiched by the pair of ribs 61, an electronic component 63 constituting the control module 20 is arranged. In this embodiment, a potting material 65 that fixes an electronic component 63 to an inter-rib region R1 is arranged in the inter-rib region R1 sandwiched between a pair of ribs 61.

In this embodiment, an electronic component 63 and a potting material 65 are arranged in an inter-rib region R1 continuously surrounded by a plurality of ribs 61. Examples of the electronic component 63 include a coil, a capacitor, a resistor, and the like. Note that an electronic component 63 and a potting material 65 may be arranged in an inter-rib region R1 continuously surrounded by a pair of ribs 61 and a side wall portion 52a. In addition, an electronic component 63 and a potting material 65 may be arranged in an inter-rib region R1 continuously surrounded by a pair of ribs 61 and a boss portion 67, which is described later.

By arranging ribs 61 and a potting material 65 as described above, a separate member to protect an electronic component 63 becomes unnecessary. In addition, a separate member to retain the potting material 65 becomes unnecessary. Therefore, it is easy to miniaturize the control case 52. Examples of the potting material 65 include urethane resin, silicon resin, epoxy resin, and the like.

In this embodiment, the control case 52 includes a rib 61 arranged at a position adjacent to an electronic component 63 constituting the control module 20. Note that, in the illustrated example, a rib 61 is also arranged at a position not adjacent to an electronic component 63.

As illustrated in FIG. 4, in the first housing space E1, an electronic component 63 and a circuit board 69 on which the electronic component 63 is mounted are arranged. In this embodiment, although not illustrated, an electronic component 63 and a circuit board 69 on which electronic component 63 is mounted are arranged in the second housing space E2. As illustrated in FIG. 3, on the bottom wall portion 52b, a boss portions 67 that projects in at least one direction of the up-down direction Z is formed. To the boss portion 67, the circuit board 69 is fastened by a screw.

The control case 52 includes a heat exchange portion 70 inside which a flow path 71 through which a heating medium to perform heat exchange with the control module 20 flows is formed. Examples of the heating medium include cooling water, cooling oil, a refrigerant gas such as difluoromethane, nitrogen, air, and the like.

The heat exchange portion 70 is integrally formed with the pair of mounting fixing portions 52e. Examples of being integrally formed include fastening by a bolt, joining by a rivet, welding, brazing, casting, forging, cutting, grinding, and the like.

In this embodiment, the heat exchange portion 70 is integrally formed with the pair of mounting fixing portions 52e by using the same material. In this embodiment, the heat exchange portion 70 is formed in the control case 52 by at least one of casting, cutting, or grinding. In this embodiment, a flow path 71 is formed inside the bottom wall portion 52b.

In this embodiment, a flow path 71 is formed inside a rib 61. In this embodiment, a flow path 71 is formed inside a rib 61 that is arranged at a position adjacent to an electronic component 63. In this embodiment, a flow path 71 is formed inside a plurality of ribs 61 that are arranged at positions at which the plurality of ribs 61 continuously or intermittently surround an electronic component 63. Note that the control case 52 also includes, as illustrated in FIG. 4, a rib 61 in which no flow path 71 is formed.

The heat exchange portion 70 is arranged at a position sandwiched between the pair of mounting fixing portions 52e. In this embodiment, the heat exchange portion 70 is arranged at a position overlapping the pair of mounting fixing portions 52e in the target direction view along the target direction (second direction Y). In this embodiment, a rib 61 extending in the target direction is arranged at a position overlapping the pair of mounting fixing portions 52e in the target direction view along the target direction (second direction Y).

### Other Embodiments

Next, other embodiments of the vehicle control device 10 and the vehicle drive device 11 are described below.

(1) In the above-described embodiment, the configuration in which the motive power transmission mechanism GT includes the deceleration device 13 and the differential gear device 14 and the control module 20 includes the inverter module 21 and the power source module 22 is described as an example. However, the embodiment of the vehicle control device 10 is not limited to such a configuration. For example, the motive power transmission mechanism GT does not have to include the deceleration device 13 or the differential gear device 14. In addition, for example, the control module 20 does not have to include the inverter module 21 or the power source module 22.

(2) In the above-described embodiment, the configuration in which the power source module 22 is arranged in the first housing space E1 and the inverter module 21 is arranged in the second housing space E2 is described as an example. However, the embodiment of the vehicle control device 10 is not limited to such a configuration. For example, the inverter module 21 may be arranged in the first housing space E1, and the power source module 22 may be arranged in the second housing space E2. In addition, for example, the first housing space E1 does not have to be formed on the upper side Z1 of the bottom wall portion 52b. In addition, for example, the second housing space E2 does not have to be formed on the lower side Z2 of the bottom wall portion 52b.

(3) In the above-described embodiment, the configuration in which the control case 52 includes the side wall portion 52a arranged to surround the control module 20 from the outer side in horizontal directions and the pair of mounting fixing portions 52e are arranged on outer surfaces of the side wall portion 52a facing opposite to each other is described as an example. However, the embodiment of the vehicle control device 10 is not limited to such a configuration. For example, the pair of mounting fixing portions 52e may be arranged on outer surfaces of the side wall portion 52a that are outer surfaces facing obliquely downward and that does not face opposite to each other. In addition, for example, at least a one direction side of the control module 20 in a horizontal direction may be covered by a member different from the control case 52.

(4) In the above-described embodiment, the configuration in which the heat exchange portion 70 is arranged at a position overlapping the pair of mounting fixing portions 52e in the target direction view along the target direction (second direction Y) is described as an example. However, the embodiment of the vehicle control device 10 is not limited to such a configuration. For example, the heat exchange portion 70 may be arranged at a position sandwiched between the pair of mounting fixing portions 52e, and arranged at a position shifted to the upper side Z1 or the lower side Z2 with respect to the pair of mounting fixing portions 52e in the target direction view.

(5) In the above-described embodiment, the configuration in which the control case 52 includes the bottom wall portion 52b that covers at least a portion of the control module 20 from the lower side Z2 and a rib 61 is formed on the bottom wall portion 52b is described as an example. However, the embodiment of the vehicle control device 10 is not limited to such a configuration. For example, a rib 61 does not have to be formed on the bottom wall portion 52b of the control case 52. In addition, for example, the control case 52 may have a configuration not including the bottom wall portion 52b.

(6) In the above-described embodiment, the configuration in which an electronic component 63 and a potting material 65 are arranged in an inter-rib region R1 that is sandwiched between a pair of ribs 61 is described as an example. However, the embodiment of the vehicle control device 10 is not limited to such a configuration. For example, a potting material 65 does not have to be arranged in an inter-rib region R1. In addition, for example, an electronic component 63 may be adjacent to only one rib 61 and does not have to be sandwiched by a pair of ribs 61.

(7) In the above-described embodiment, the configuration in which the control case 52 includes a rib 61 that is arranged at a position adjacent to an electronic component 63 constituting the control module 20 and a flow path 71 is formed inside the rib 61 is described as an example. However, the embodiment of the vehicle control device 10 is not limited to such a configuration. For example, it may be configured such that no flow path 71 is formed inside a rib 61 that is arranged at a position adjacent to the electronic component 63. In addition, for example, the control case 52 does not have to have a rib 61 arranged at a position adjacent to the electronic component 63 constituting the control module 20.

(8) In the above-described embodiment, the configuration in which the control case 52 is supported suspended from the vehicle body 12a by the pair of mounting members 54 is described as an example. However, the embodiment of the vehicle control device 10 is not limited to such a configuration. For example, it may be configured such that portions of the mounting members 54 that come into contact with the mounting fixing portions 52e are located on the lower side Z2 of the control case 52.

(9) In the above-described embodiment, the configuration in which the vehicle drive device 11 includes the drive device case 51 that houses the rotary electric machine MG and the motive power transmission mechanism GT is described as an example. However, the embodiment of the vehicle drive device 11 is not limited to such a configuration. For example, the drive device case 51 does not have to house the rotary electric machine MG or the motive power transmission mechanism GT. In addition, for example, the vehicle drive device 11 does not have to include the rotary electric machine MG, the motive power transmission mechanism GT, and the drive device case 51.

(10) Note that the configuration disclosed in the embodiment described above can be applied in combination with a configuration disclosed in the other embodiments as long as no contradiction arises. With regard to the other configurations, the embodiments disclosed herein are described only as examples in all respects. Therefore, various modifications can be made as appropriate without departing from the spirit and scope of this disclosure.

### Summary of Above-Described Embodiments

The vehicle control device and the vehicle drive device according to this disclosure are described below.

In one aspect of embodiment, a vehicle control device is a vehicle control device including: a control module that includes an inverter for drive-controlling a rotary electric machine, and at least one of a voltage conversion circuit (a first DC-DC converter, a second DC-DC converter) performing conversion of voltage for an in-vehicle battery (a first battery, a second battery), a charging circuit (an in-vehicle charger) performing charging from an external power source to the in-vehicle battery, and a power supply circuit (the in-vehicle charger) performing power supply from the in-vehicle battery to an outside of a vehicle, being electrically connected to the in-vehicle battery (the first battery, the second battery); a pair of mounting members that are connected to a vehicle body of the vehicle (12); and a control case that houses the control module, the control case includes: a pair of mounting fixing portions to which each of the pair of mounting members is fixed; and a heat exchange portion forming inside a flow path through which a heating medium for performing heat exchange with the control module flows, and the heat exchange portion is arranged at a position sandwiched between the pair of mounting fixing portions and is integrally formed with the pair of mounting fixing portions.

According to this configuration, since the heat exchange portion forming inside the flow path is integrally formed with the pair of mounting fixing portions at a position sandwiched between the pair of mounting fixing portion, it is easy to increase rigidity of a portion of the control case between the pair of mounting fixing portions. This configuration can suppress deformation of the control case due to a load exerted from the pair of mounting members on the control case. Therefore, a load exerted on the control module housed in the control case can be suppressed.

In another aspect of embodiment, the control case may include a side wall portion being arranged in such a way as to surround the control module from an outside in a horizontal direction, the pair of mounting fixing portions may be arranged on outer surfaces of the side wall portion, the outer surfaces facing opposite to each other, and the heat exchange portion may be, with a direction in which the pair of mounting fixing portions are linked to each other being defined as a target direction (second direction), arranged at a position overlapping the pair of mounting fixing portions in a target direction view along the target direction (second direction).

According to this configuration, since the heat exchange portion is arranged at a position overlapping the pair of mounting fixing portions in the target direction view, deformation of portions of the side wall portion on which the pair of mounting fixing portions are arranged can be suppressed. Therefore, a load exerted on the control module arranged at a position surrounded by the side wall portion can be suppressed.

In still another aspect of embodiment, the control case may include: a side wall portion being arranged in such a way as to surround the control module from an outside in a horizontal direction; and a bottom wall portion covering at least a part of the control module from a lower side, the pair of mounting fixing portions may be arranged on outer surfaces of the side wall portion, the outer surfaces facing opposite to each other, and, on the bottom wall portion, a rib projecting in an up-down direction and also extending in a horizontal direction may formed.

According to this configuration, due to the rib being formed on the bottom wall portion of the control case, rigidity of the bottom wall portion can be increased, and eventually, deformation of the side wall portion on which the pair of mounting fixing portions are arranged can be suppressed. Therefore, a load exerted on the control module arranged at a position surrounded by the side wall portion and the bottom wall portion can be suppressed.

In still another aspect of embodiment, the control case may include a bottom wall portion that covers at least a part of the control module from a lower side, on the bottom wall portion, a pair of ribs both of which project in an up-down direction and also extend in a horizontal direction may be formed, and in an inter-rib region sandwiched by the pair of ribs, an electronic component that constitutes the control module and a potting material that fixes the electronic component to the inter-rib region may be arranged.

According to this configuration, the electronic component can be arranged by using the inter-rib region sandwiched by the ribs for increasing rigidity of the bottom wall portion. Therefore, it is easy to achieve both securement of rigidity and miniaturization of the control case at the same time. In addition, not only can rigidity of the control case be increased but also protection of the electronic component can be achieved by the potting material.

In still another aspect of embodiment, the control case may include: a bottom wall portion that covers at least a part of the control module from a lower side; and a rib that is formed in such a way as to project in an up-down direction from the bottom wall portion and also extend in a horizontal direction and that is arranged at a position adjacent to an electronic component constituting the control module, and inside the rib, the flow path may be formed.

According to this configuration, the electronic component can be efficiently cooled by heat exchange with a heating medium flowing through the flow path formed inside the rib.

In still another aspect of embodiment, the control case may be supported by being suspended from the vehicle body by the pair of mounting members.

When a configuration in which the control case is supported by being suspended from the vehicle body by the pair of mounting members is employed, a load exerted from the pair of mounting members on the control case is likely to increase. According to this configuration, even when the configuration as described above is employed, deformation of the control case can be suppressed by increasing rigidity of a part of the control case between the pair of mounting fixing portions.

In still another aspect of embodiment, a vehicle drive device includes: the above-described vehicle control device; the rotary electric machine; an output member that is drivingly connected to a wheel; a motive power transmission mechanism that transmits driving force between the rotary electric machine and the output member; and a drive device case that houses the rotary electric machine and the motive power transmission mechanism, and the control case is joined to the drive device case or is integrally formed with the drive device case.

Since when a configuration in which the control case is joined to the drive device case or is integrally formed with the drive device case is employed, loads of not only the control case but also the drive device case are configured to be supported by the pair of mounting members, a load exerted from the pair of mounting members on the control case is likely to increase. According to this configuration, even when the configuration as described above is employed, deformation of the control case can be suppressed by increasing rigidity of a part of the control case between the pair of mounting fixing portions.

The vehicle control device and the vehicle drive device according to this disclosure are only required to achieve at least one of the above-described advantageous effects.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle control device comprising: a control module that includes an inverter for drive-controlling a rotary electric machine, and at least one of a voltage conversion circuit performing conversion of voltage for an in-vehicle battery, a charging circuit for performing charging from an external power source to the in-vehicle battery, and a power supply circuit for performing power supply from the in-vehicle battery to an outside, which are electrically connected to the in-vehicle battery; a pair of mounting members that are connected to a vehicle body of a vehicle; and a control case that houses the control module, wherein
the control case includes: a pair of mounting fixing portions to which each of the pair of mounting members is fixed; and a heat exchange portion forming inside a flow path through which a heating medium for performing heat exchange with the control module flows, and
the heat exchange portion is arranged at a position sandwiched between the pair of mounting fixing portions and is integrally formed with the pair of mounting fixing portions.

2. The vehicle control device according to claim 1, wherein
the control case includes a side wall portion being arranged in such a way as to surround the control module from an outside in a horizontal direction,
the pair of mounting fixing portions are arranged on outer surfaces of the side wall portion, the outer surfaces facing opposite to each other, and
the heat exchange portion is, with a direction in which the pair of mounting fixing portions are linked to each other being defined as a target direction, arranged at a position overlapping the pair of mounting fixing portions in a target direction view along the target direction.

3. The vehicle control device according to claim 1, wherein
the control case includes: a side wall portion being arranged in such a way as to surround the control module from an outside in a horizontal direction; and a bottom wall portion that covers at least a part of the control module from a lower side,
the pair of mounting fixing portions are arranged on outer surfaces of the side wall portion, the outer surfaces facing opposite to each other, and,
on the bottom wall portion, a rib projecting in an up-down direction and also extending in a horizontal direction is formed.

4. The vehicle control device according to claim 1, wherein
the control case includes a bottom wall portion that covers at least a part of the control module from a lower side,
on the bottom wall portion, a pair of ribs both of which project in an up-down direction and also extend in a horizontal direction are formed, and,
in an inter-rib region sandwiched by the pair of ribs, an electronic component that constitutes the control module and a potting material that fixes the electronic component to the inter-rib region are arranged.

5. The vehicle control device according to claim 1, wherein
the control case includes: a bottom wall portion that covers at least a part of the control module from a lower side; and a rib that is formed in such a way as to project in an up-down direction from the bottom wall portion and also extend in a horizontal direction and that is arranged at a position adjacent to an electronic component constituting the control module, and,
inside the rib, the flow path is formed.

6. The vehicle control device according to claim 1, wherein the control case is supported by being suspended from the vehicle body by the pair of mounting members.

7. The vehicle control device according to claim 2, wherein the control case is supported by being suspended from the vehicle body by the pair of mounting members.

8. The vehicle control device according to claim 3, wherein the control case is supported by being suspended from the vehicle body by the pair of mounting members.

9. The vehicle control device according to claim 4, wherein the control case is supported by being suspended from the vehicle body by the pair of mounting members.

10. The vehicle control device according to claim 5, wherein the control case is supported by being suspended from the vehicle body by the pair of mounting members.

11. A vehicle drive device comprising:
the vehicle control device according to claim 1;
the rotary electric machine;
an output member that is drivingly connected to a wheel;
a motive power transmission mechanism that transmits driving force between the rotary electric machine and the output member; and
a drive device case that houses the rotary electric machine and the motive power transmission mechanism, wherein
the control case is joined to the drive device case or is integrally formed with the drive device case.

12. A vehicle drive device comprising:
the vehicle control device according to claim 2;
the rotary electric machine;
an output member that is drivingly connected to a wheel;
a motive power transmission mechanism that transmits driving force between the rotary electric machine and the output member; and
a drive device case that houses the rotary electric machine and the motive power transmission mechanism, wherein
the control case is joined to the drive device case or is integrally formed with the drive device case.

13. A vehicle drive device comprising:
the vehicle control device according to claim 3;
the rotary electric machine;
an output member that is drivingly connected to a wheel;
a motive power transmission mechanism that transmits driving force between the rotary electric machine and the output member; and
a drive device case that houses the rotary electric machine and the motive power transmission mechanism, wherein
the control case is joined to the drive device case or is integrally formed with the drive device case.

14. A vehicle drive device comprising:
the vehicle control device according to claim 4;
the rotary electric machine;
an output member that is drivingly connected to a wheel;
a motive power transmission mechanism that transmits driving force between the rotary electric machine and the output member; and
a drive device case that houses the rotary electric machine and the motive power transmission mechanism, wherein
the control case is joined to the drive device case or is integrally formed with the drive device case.

15. A vehicle drive device comprising:
the vehicle control device according to claim 5;
the rotary electric machine;
an output member that is drivingly connected to a wheel;
a motive power transmission mechanism that transmits driving force between the rotary electric machine and the output member; and
a drive device case that houses the rotary electric machine and the motive power transmission mechanism, wherein
the control case is joined to the drive device case or is integrally formed with the drive device case.
